(19) United States
(12) Patent Application Publication
(10) Pub. No.: US 2007/0058854 A1
(43) Pub. Date: Mar. 15, 2007

(54) Gear pattern inspection system

(76) Inventors: Gregory T. Caskey, Holland, MI (US); Roland E. DeGraaf, Holland, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/520,938

(22) Filed: Sep. 14, 2006

Related U.S. Application Data
(60) Provisional application No. 60/716,814, filed on Sep. 14, 2005.

(51) Int. Cl. G06K 9/00

(52) U.S. Cl. 382/152

(57) ABSTRACT

A method and apparatus for evaluating gears includes an imaging system that provides a non-contact method of evaluating gear meshing using technology that is quick, robust, and provides information not available at production rates from human inspection. The method and apparatus includes one or more imaging devices, illumination, and a computer program to rapidly evaluate the quality of gear set meshing, and which anticipates the move to three-dimensional imaging to permit upstream evaluation of gear quality prior to mating.

### CROSS-REFERENCE TO RELATED APPLICATION

This application claims priority from U.S. Pat. application Ser. No. 60/716,814, filed Sep. 14, 2005, entitled GEAR PATTERN INSPECTION SYSTEM, which is incorporated by reference herein in its entirety.

### TECHNICAL FIELD AND BACKGROUND OF THE INVENTION

This invention relates to a common problem among those who produce gear sets.

Spiral bevel, hypoid and other similar gears are used in, for example, power train units in automobiles, trucks and other transportation applications. They are also used on farm machinery, manufacturing machinery, heavy equipment drive trains and in aerospace and various other forms of machinery where power is transmitted through gears. One particular example is their use in transmissions and differentials of cars, trucks, busses and the like. For differentials, these gears are usually mated in pairs of a ring gear and a pinion gear, for example. The pinion gear transmits power to the ring gear, which in turn drives the rotating axles that go to wheels, in this example. If power is to be transmitted well, the pinion gear must mate with the ring gear properly. It is the aim of this invention to evaluate the quality of that mating.

To see how gears mate, it is common to apply, for example, a colored oil, or a blue dye solution commonly used in precision machining. Then the gears are mated and spun in a fixture or in an assembly that permits the mating gears to contact one another under conditions similar to intended end-use operation. Surfaces that contact during spinning push aside or otherwise wear the colorant-laced liquid leaving substantially bare metal where contact occurred. At this point, visual inspection can detect the location and other characteristics of the contact area, and a decision can be made about whether the gear pair is mated correctly, or needs either adjustment or reworking, or must be discarded as scrap. At production rates, this is a quick judgement of experienced persons, and is therefore subject to all the problems faced by people when involved in a tedious, subjective, repetitive and fast-paced operation. It is the object of this invention to replace the human judgment with an imaging solution that is as able to conduct this operation without suffering from tedium, replace subjective with objective and repeatable measures, and be able to operate robustly at manufacturing rates.

Accordingly, the present invention provides a method and apparatus that replaces human judgment with an imaging system. Optionally, the system may provide backward compatibility (able to return to human inspection if this invention is damaged or being serviced) by replacing the human element of the process without changing the procedure.

### SUMMARY OF THE INVENTION

Accordingly, the present invention provides a method and apparatus for evaluating the contact surfaces of a gear using an imaging system.

In one form of the invention, a gear inspection system includes at least one imaging device, means for rotating the gear during an inspection cycle, and a processor for analyzing the image and, optionally, for storing the image. The imaging device gathers images of the flanks of the teeth of the gear during the inspection cycle, and the processor processes the images and uses the images to analyze the contact areas of the teeth to evaluate the gear.

In one aspect, the imaging device gathers images of the flanks of the teeth of the gear while the gear is rotating.

In further aspects, the inspection apparatus includes a pair of imaging devices, with one of the imaging devices gathering images of the first flanks of the gear teeth and the other device gathering images of the second flanks of the gear teeth. For example, a suitable imaging device includes a camera, such as a color camera.

In another aspect, the apparatus further includes a light source for illuminating each flank of the teeth while the imaging device gathers the images. For example, the light source may comprise a strobe light.

In other aspects, the processor is programmed to analyze the images after all the images of the flanks of the teeth are gathered. Alternately, the processor may be programmed to analyze an image of one or more flanks prior to gathering all of the images of all flanks of the teeth.

In yet a further aspect, a contrast medium is applied to the teeth of the gear before or while being driving by another gear, wherein the imaging device generates images of the flanks with a greater contrast between the contact areas on the flanks where the contrast medium has been worn off and the remaining areas of the flanks where the contrast medium remains.

To evaluate a gear, the processor may compare the pattern of the contact areas on the inspected gear to the pattern of a reference gear. For example, the processor may compare the pattern of the contact areas of the inspected gear to known good or bad patterns. For example, in one method, the processor may divide the flanks of the teeth into grid areas and then compare the pattern of the contact areas on the grid areas to the patterns on a grid area of a reference gear. The reference may be a physical “master” gear, or may be a non-physical representation, such as a digital pattern stored in the processor.

In any of these variations, the apparatus may include a sensor that detects when the gear is in the field of view of the imaging device. For example, the sensor may be in communication with the processor, and may generate a discrete logic pulse, for example, to trigger an inspection cycle.

According to another form of the invention, a method of inspecting a gear includes providing an imaging device, rotating the gear, and gathering images of the flanks of the gear teeth with the imaging device while rotating the gear and then analyzing the images of the flanks of the gear teeth to evaluate the contact areas on the teeth to determine whether the contact areas are acceptable.

In one aspect, the method includes providing a processor, which analyzes the images.

In further aspect, each flank of each tooth is illuminated while the images are gathered. For example, a strobe light may be used to illuminate the flanks of the gear teeth.

In one method, all the images are gathered prior to analyzing images. In an alternate method, the image of the flank of one tooth is gathered and then analyzed before gathering the remaining images.

In further aspect, a contrast medium is applied to the teeth of the gear, which is then driven to generate contact areas on the teeth. The contrast medium creates a contrast between the contact area and remaining area of the flank of each tooth. For example, the contrast medium may include a fluid that is applied to the flanks of the gear.

According to yet a further aspect, the processor includes a reference pattern of an acceptable or unacceptable contact area pattern and compares the pattern of the contact areas of the analyzed gear to the reference pattern to evaluate whether the analyzed gear is acceptable or not. For example, the processor may divide each flank of the teeth into a grid with a plurality of grid areas and then compare the pattern of the contact area relative to the grid areas to the reference pattern on a corresponding grid area of the reference tooth. In addition, the method may further include indicating selected grid areas of the grid on the reference tooth where contact areas may occur and then comparing the correspondence between the locations of the contact areas relative to the grid areas of the analyzed tooth to the contact areas on the grid areas of the reference tooth.

In a further aspect, the method includes providing at least two imaging devices with one gathering images of one set of flanks of the gear teeth and the other gathering images the other set of flanks of the gear teeth.

Accordingly, the apparatus and method of the present invention mimics the same steps a human inspector would do to the extent possible, by using an imaging device, such as a color camera and lighting, such as strobe lighting, a processor, such as a PC type computer, and application software. After spinning the gears for a period of time to produce the pattern where gears were in contact, the gear is spun at a rate commensurate with the imaging system's ability to record images of each gear tooth. Since each gear tooth has two flanks, two views must be recorded. The images are then analyzed via specialized methods to evaluate those characteristics believed important by gear manufacturers. These characteristics may include the centering of contact areas on the face of the gear teeth, how the centering changes from tooth to tooth, and the general shape characteristics of the contact area. Further, the images may be analyzed by analyzing the largest contiguous contact region, or a plurality of contiguous but non-overlapping contact regions, for area, center position, extents, perimeter, aspect ratio, and variation in tooth to tooth of any one or more of these characteristics. However, it should be understood that it is not the aim here to limit the present invention to any particular set of evaluation criteria and, instead, to provide useful examples of such evaluation including any further extensions or variations that would be understood or appreciated to those skilled in the art of gear contact pattern analysis.

These and other objects, advantages, purposes, and features of the invention will become more apparent from the study of the following description taken in conjunction with the drawings.

### DESCRIPTION OF THE FIGURES

FIG. 1 shows a schematic system of a preferred embodiment for an inspection apparatus 100 for inspecting a gear 101, such as spiral bevel, hypoid or other types of gear with teeth that extend beyond the edge of the gear body. Gear 101 is rotated about it's cylindrical axis 101a and the gear teeth interrupt a through beam optical sensor 102, which in turn triggers a light source 103, such as a strobe light, and two cameras 104 and 105 viewing opposite flanks of each gear tooth. Each of the cameras view the gear teeth nearly straight on.

FIG. 2 is a sketch of a set 200 of idealized gear contact area patterns as viewed on successive teeth 201 on a gear. The contact areas 202, after running the gears together, colored oil or blue dye, or any other contrast medium, will show substantially bare metal compared to the balance of the tooth. Successive teeth show the areas with a pattern moving from one place to another. If the pattern is too far off the design location, then the gear set requires adjusting or discarding. Moreover, if the gear pattern wanders, even if it is within the desired design location within tolerance, the wander from side to side or up and down can indicate problems in either gear manufacturing or in assembly.

FIG. 3 shows a flowchart of a computer program designed to first accept a signal indicating the gear set is ready to test, then gathering images of each tooth (both flanks) until all teeth in the gear are imaged. Following image acquisition of all gear teeth, each image is analyzed independently for location, height, width and any other desired feature of the pattern location. Once all teeth are analyzed to ensure compliance on a tooth by tooth basis, the whole of the data can be analyzed for trends in the pattern wandering from side to side during rotation, or other effects.

FIG. 4 shows a flowchart similar to that of FIG. 4, but here each tooth is analyzed during the gear rotation. If the analysis can be done quickly, then there is time for the computer to work on one image while the next is being gathered. This can save time by more effectively utilizing computer resources. The image acquisition does not necessarily require computer CPU intervention.

FIG. 5 shows a set of sample graphs 501 and 502 for two gears analyzed by the method herein. The first graph 501 shows the horizontal 503 and vertical 504 position of a gear pattern. A second similar diagram 502 for another set of gear teeth shows the same type of horizontal position 505 and vertical position 506 of the pattern as a function of tooth number. Values can be either in common units (e.g. mm or inches) or in percentage of tooth dimension, whichever is desired. The horizontal position of the pattern is relatively constant from tooth to tooth for both graphs 501 and 502 as can be seen by the solid lines 503 and 505. However the dashed line 506 in the second graph shows considerably more variation in vertical position than is indicated by a similar set of data 504 for the first graph.

FIG. 6 shows a method 600 of dividing an idealized gear tooth 601 with a gear pattern 602 into a grid of areas 603, such as rectangles. An image gathered by camera has a well defined left and right side, top and bottom of tooth, and can be similarly divided into the same number of grid areas as the idealized tooth 601. The pattern on the gear is then compared grid area by grid area to the same grid areas on the idealized pattern. If both show a contact pattern indicating actual gear surface or both indicate non-contact regions, then a “match” counter is incremented. If either the ideal pattern or the actual tooth pattern, but not both, show either condition, then a “non-match” counter is incremented. Bad patterns are identified by as set of areas connected together that, when viewed, appear to experts to be unacceptable. For each bad pattern, at least one pattern shifted or sized should be included that is just within acceptable limits. The pattern is then matched to a set of good and bad patterns, and the pattern closest to that of the actual tooth then determines the pass/fail and reason for pass/fail (if pattern) for the gear.

### DESCRIPTION OF THE INVENTION

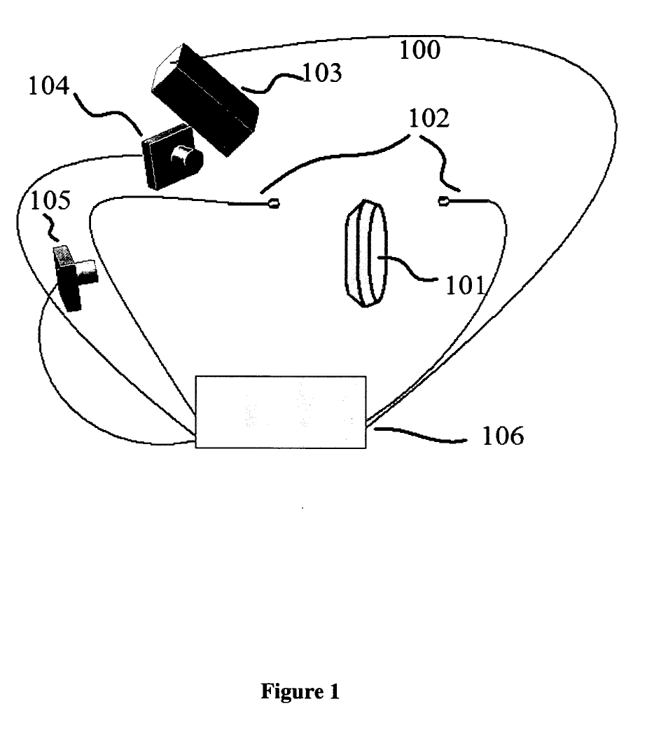

Referring to FIG. 1, the numeral 100 generally designates a gear inspection apparatus of the present invention. Gear inspection apparatus 100 includes an imaging system for inspecting a gear 101, such as a spiral bevel or other types of gears, and a means for rotating the gear while inspecting the gear. For example, suitable means for rotating the gear include another gear, including a motor gear, a rotating shaft, a robotic arm, or a rotating table or the like. The imaging system includes one or more imaging devices 104, 105, such as cameras, which are used to collect or gather images of the gear's teeth, and a controller 106. In the illustrated embodiment, the imaging system includes a pair of imaging devices 104, 105, for gathering images from both flanks of the gear tooth.

Controller 106 is in communication with imaging devices 104, and 105 and is configured to collect the images from the imaging devices and further process the images in a manner described in more detail below. As will be more fully described below, some of all of the processing may be performed by the imaging devices themselves. The imaging process may be initiated by a trigger. For example, when a gear is placed in apparatus 100 for inspection, the gear's teeth may be used to trigger the image acquisition process. In the illustrated embodiment, the gear's teeth are used to trigger a sensor 102, such as a through-beam optical sensor, by interrupting the through-beam. A suitable through-beam optical sensor includes a fiber optic through beam sensor such as an Omron model E3X-DA11-X fiber optic amplifier with E32-TC200 fiber optic cables terminated in SMA connectors available from Omron Distributors such as Grand Technologies of Grand Rapids, Mich.

However, other types sensors may be used, as would be understood by those skilled in the art of factory automation.

Sensor 102 generates a trigger signal, which triggers the acquisition of images from the two imaging devices. The trigger signal is sent to a set of frame grabbers, coupled to the imaging devices—one for each imaging device. For example, suitable frame grabbers are available from Epix, Inc. model PIXCI-D2X frame grabbers. As noted, suitable imaging devices include cameras, including color cameras such as CMOS color cameras from Epix, Inc. model SV2112C, all available with connecting cable from Epix, Inc. of Buffalo Grove, Ill., USA. Optionally, the color cameras may be fitted with an infrared cut filter, which is also available from the camera manufacturer, though this is not always necessary or desirable, as will be appreciated by those skilled in the art of near-infrared/ visible imaging.

Prior to the inspection process or cycle, gear 101 is driven to create a contact area on each of the gear teeth, which contact areas are analyzed using the gear inspection apparatus of the present invention. For example, the contact area's location size, shape on each flank of each tooth may be evaluated as well as the pattern of the contact areas on the gear. To generate the contact areas, each gear to be inspected is placed in a rotational means that permits putting the gears in relatively nominal operational positions, including fully operational positions in the final assembly. This rotational means may include another gear connected to a motor, which is mated to the gear being inspected. In this manner, the gear set may be rotated in either or both forward and reverse directions, depending on the manufacturer's needs. Alternately, the gear may be spun in only one direction, but done so in a way that still produces contact patterns on both flanks of the gear, if both flanks of the gear are being imaged and/or evaluated as would be understood to those skilled in the art of producing gear contact patterns. Also, to enhance the contrast (if needed) of the contact areas on the gear teeth, the gear may have had a contrast or contrasting medium, such as a liquid or other substance, applied to the teeth before they are driven by the other gear, which for example, may be colored differently from the gear material (or other additives or liquids are used that perform the same task) such that the imaging device can produce images that exhibit a contrast between the contact area on the gear face or flank itself, and the medium covering it. This medium has the property that it flows slowly or not at all during this rotational operation. This permits the drive gear to contact or push away the medium where gears contact, and yet the substance remains where there is no contact. It is then these contact areas and their patterns that are inspected.

As detailed above, first the gear is spun in one direction, then, if desired, the other direction to generate contact areas on both flanks of all the teeth. After being spun, the gear faces are then imaged one a time by the imaging system or in some cases many at a time. The images are then collected by controller 106 for processing and analysis. Imaging during rotation may require some form of stop-action to avoid blurred images that cannot be reasonably analyzed. This stop-action may be provided by a light source 103, such as a strobe light and/or an electronic shutter in the camera.

Each image is then analyzed to determine the borders between bare gear material and the medium or substance applied for contrast or other clear boundary if no contrast medium is used. Various methods to analyze the images are described herein. For example, the specific locations of the contact areas relative to edges of gear's flank may be determined and may be used to evaluate the centering of the contact area relative to the overall face or flank of each gear tooth. The size and shape of the contact area can also be examined to evaluate such things as percentage of the tooth over which contact occurred, whether the contact areas tends to move inward then back outward (or up then back down) in going from tooth to tooth (commonly called runout in the art of precision machining) and whether the contact area is contiguous or in separate areas on a tooth, for example. Some or all of these factors may be important to those engaged in manufacturing power train gears.

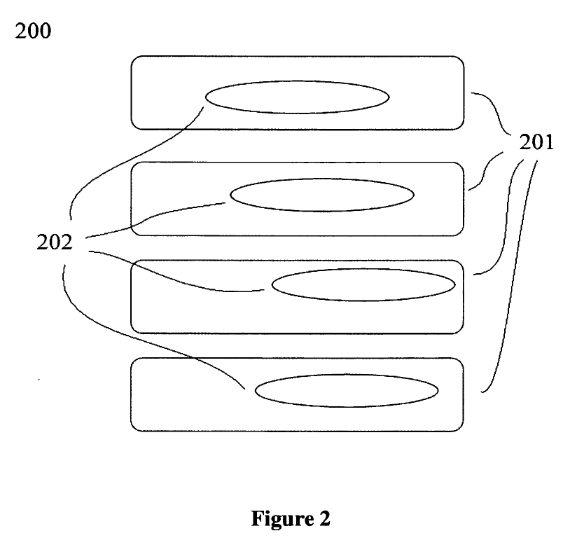

Referring to FIG. 2, the numeral 200 designates a set of idealized gear contact areas and pattern as viewed on successive teeth 201 on a gear. The oval areas 202 are where, after running the gears together, the contrast medium, such as colored oil or blue dye, or any other contrast medium, will show substantially bare metal created by the contact with the other gear, compared to the balance of the tooth. If no contrast medium is used, then we assume there is sufficient variation in flank appearance between contact and non-contact regions to permit analysis. Successive teeth show a pattern with the contact areas moving from one place to another. If the pattern is too far off the design location, then the gear set requires adjusting or discarding. Moreover, if the gear or contact areas wander, even if they are within the desired design location within tolerance, the wander from side to side or up and down can indicate problems in either gear manufacturing or in assembly.

As noted above, the imaging devices may comprise cameras. The camera may be either black and white, or color as noted above, depending on the needs of the programmer and the materials involved. In one preferred embodiment the imaging devices comprise color digital megapixel cameras designed for machine vision applications. These cameras provide for a digital interface, plus the ability to transfer only those parts of an image that are of interest, thereby saving time. Also envisioned is the use of infrared or other wavelengths of light that may not be humanly visible, but which would show contrast of the contact areas just as well when an appropriate imaging means is used. For example, the present invention may make use of ultrasonic images, three dimensional images, and other types of imaging that vary significantly from the imaging done in a camera used in the manner described above, and for which the light source is replaced by some other image generating means.

In one preferred embodiment, one imaging device is aimed so as to view relatively completely one flank of each gear tooth, and the other device views the other flank of each tooth. The devices may be encased in a specially designed housing that permits rotation of the camera about two axes, plus linear translation in at least on direction. All of these movements can aid in assuring that the imaging devices properly view the flanks of gear teeth, but can be replaced by fixed mounts.

Alternatively, one imaging device can be used with optics (e.g. mirrors) that look either at one flank then the other, or in fact may simply split the imaging device field of view with, for example, the upper portion of the image viewing one flank of the gear tooth and the lower portion of the image viewing the other flank of the gear tooth. This latter method requires less electronic hardware but more machined and optical hardware, and takes advantage of the entirety of the imager that may not otherwise be used (for example, most spiral bevel gears have significantly more “length” of tooth than “height” of tooth). The many and various ways of arranging imaging device and optics can be envisaged to all produce the same general effect.

As noted above, imaging devices 104, 105 are linked to controller 106, such as a typical or custom personal computer (PC) through appropriate links. Many such links are available. These include standard video coaxial cable running to a frame grabber on the PC, or, using cameras with digital interfaces, a digital connection to the PC. Such digital connections include, but are not limited to, CameraLink™ (trademark of Pulnix Corporation), Firewire (IEEE1394) or other digital link, analog or any other means. One preferred embodiment utilizes a digital LVDS cable assembly manufactured by Epix Inc. and connects a SV2112C camera to a Epix PIXCI-CL1 frame grabber mounted in a PCI slot in the (PC) computer. The fiber optic sensor is connected to the frame grabber, and the frame grabber controls all image acquisition activity into the computer's memory.

Optionally, the computing means may reside in the imaging system itself, with only input/output (I/O) or other information being used externally but with the processing performed within the imaging device or camera system itself. However, the PC permits highly versatile means of evaluating images, storing images, and permits remote access for process engineers, managers, or even service personnel.

Located somewhere near the gear itself is a means to know when to image a gear tooth flank. Each flank may be imaged, or perhaps only the flanks of selected teeth, for evaluation. As described earlier, this means may be a sensor, such as a photo-optical sensor that detects when a tooth is in position. In one preferred embodiment noted above, an Omron through beam fiber optic sensor is used owing to it's relatively fast 300 μsec switching time. The optical fiber ends are placed one each flank of the gear so as to be triggered on the encountering of one of the edges of a gear tooth. We anticipate other means to trigger image acquisition, such as using an encoder on the rotational means, which would mean that we allow for methods that generate a trigger signal away from the gear itself.

Alternatively, the sensor may be an inductive proximity sensor, or may be tied to an encoder on the rotational means on the fixture that provides a regular relationship between rotational position and tooth surface. This latter method may also then be used to determine if the flank of the gear tooth is where it is designed to be. For example, if the azimuth position of a gear tooth is not regularly spaced, then it would be expected that the mating to another gear would not be proper. This would provide cause to the effect determined by camera evaluation of the contact areas. This is another feature for which the present invention can be extended beyond just evaluating the mating areas.

Once the sensor “trips,” indicating that the gear is in position for imaging, then an image is obtained and stored in the analysis means (computer) memory. This image may be evaluated during the gear rotation to the next tooth, if the analysis can proceed quickly enough, or may be pipelined to another processor for evaluation, or may simply be accumulated with other images until the imaging phase is complete, then be analyzed. If processing can be completed between teeth, then only one “framestore” is required for the images. If, however, pipelining to another processor is done, or if images are simply gathered and analyzed after all teeth have been imaged, then multiple areas must be available to store the images in the computer memory.

Should analysis be complex, or the computer relatively slow, then storing images may be required with analysis to follow the gathering of all images. This may require the gathering and storing of up to twice the number of teeth in images. Alternatively, the process engineer may decide that it is acceptable to image and analyze only a subset of the teeth.

This may then permit analysis to go on between image gathering, requiring then only one frame store.

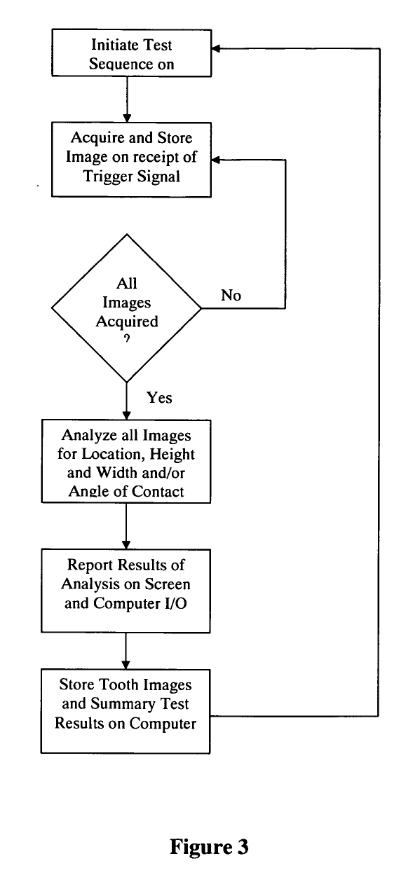

Referring to FIG. 3, a flowchart of a computer program is illustrate, which is designed to first accept a signal indicating the gear set is ready to test, then gather images of each tooth (both flanks) until all teeth in the gear are imaged. Following image acquisition of all gear teeth, each image is analyzed independently for location, height, width and/or any other desired characteristic of the contact area. Once all teeth are analyzed to ensure compliance on a tooth by tooth basis, the whole of the data can be analyzed for trends in the pattern of the contact areas wandering from side to side during rotation, or other effects.

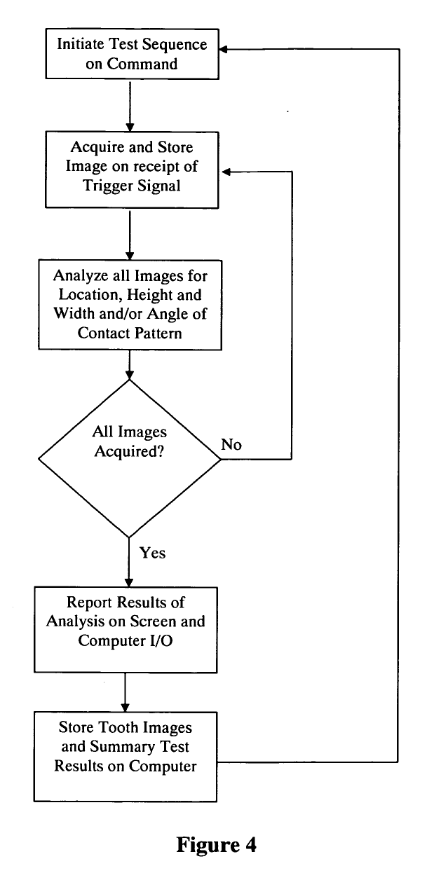

FIG. 4 shows a flowchart similar to that of FIG. 3, but here each tooth is analyzed during the gear rotation. If the analysis can be done quickly, then there is time for the computer to work on one image while the next is being gathered. This can save time by more effectively utilizing computer resources. As noted previously, the image acquisition does not necessarily require computer CPU intervention. We also anticipate that the processor may include multiple CPU personal computers, or multiple independent processors operating as individual processors, or operating in a manner that links them together, and includes methods of linking together through a supervisory processor. Hence, we anticipate multi-CPU processors that can be programmed to take advantage of multiple thread programming, thereby speeding acquisition and analysis.

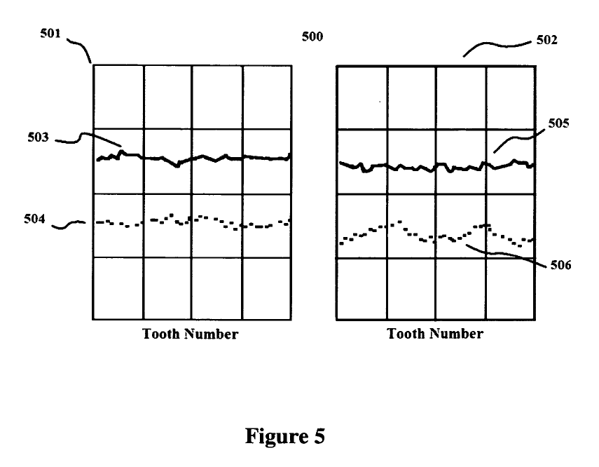

FIG. 5 shows a set of sample graphs 501 and 502 for two gears analyzed by the method herein. The first graph 501 shows the horizontal 503 and vertical 504 positions of the contact areas' pattern on a gear. A second similar diagram 502 for another set of gear teeth shows the same type of horizontal positions 505 and vertical positions 506 of the pattern as a function of tooth number. Values can be either in common units (e.g. mm or inches) or in percentage of tooth dimension, whichever is desired. The horizontal position of the pattern is relatively constant from tooth to tooth for both graphs 501 and 502 as can be seen by the solid lines 503 and 505. However the dashed line 506 in the second graph shows considerably more variation in vertical position than is indicated by a similar set of data 504 for the first graph.

One analysis of the tooth surface may involve segmenting the image of the tooth flank into areas still covered by the contrast substance, and those where the substance has been worn away. Also, the edges and top/bottom of tooth must be located, in order to assure positions of contact areas are relative to known points on the tooth surface, and not relative to the particular view of the imaging means. Standard machine vision techniques such as connectivity analysis, edge detection and other methods well known to those skilled in the art of computer aided image analysis may be used to locate and characterize contact areas. Limits can then be placed on the location of contact areas permitted; size, shape (via the method disclosed herein and, if necessary, general shape parameters common in the art) and number of contact areas permitted on a tooth; maximum deviation of contact areas from tooth to tooth; maximum variation of contact area characteristics permitted over entire set of teeth analyzed on a single gear; and other characteristics as desired by those who may be skilled in the art.

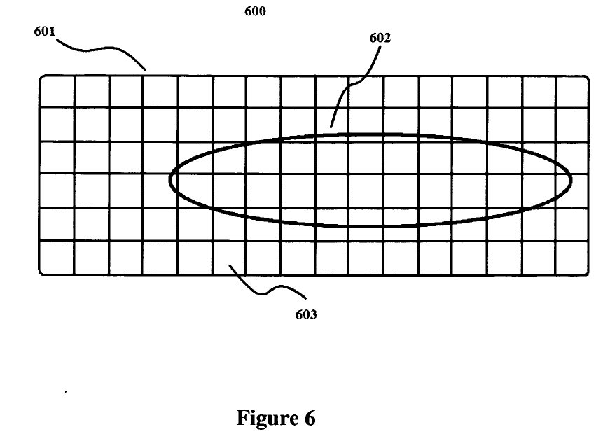

In one preferred embodiment, the method of analysis includes a dividing the entire flank of the tooth into a set number of grid areas or regions, and comparing these regions to regions in a model that represents a good pattern. Referring to FIG. 6, a method of analysis 600 includes dividing the flank of an idealized gear tooth 601 with a contact area 602 into a grid of areas or regions 603, such as rectangles. The image gathered by the imaging device has a well defined left and right side, top and bottom of tooth, and can be similarly divided into a grid of areas or regions, such as rectangles with the same number of grid areas as the idealized tooth 601. The pattern of the contact areas on the analyzed gear is then compared grid area by grid area to the same grid areas on the idealized pattern. In a preferred embodiment, the rectangle is a square and is formed such that the size of each square is 1/64^{th} of the distance from one side of a tooth to the other in the largest principal direction across the flank. If both show a contact pattern indicating actual gear surface or both indicate non-contact regions, then a “match” is indicated and a “match” counter is incremented. If either the ideal pattern or the actual tooth pattern, but not both, show either condition, then a “no match” counter is incremented. In other words, when comparing each grid area of the analyzed tooth to the corresponding grid area of the idealized tooth, if both grid areas indicate a contact area exists in that area or region or they both indicate that no contact area exists then there is a “match.” If when comparing each grid area of the analyzed tooth to the corresponding grid area of the idealized tooth, they are different—one indicates a contact area exists and the other indicates no contact area exists—then there is “no match.” This may be repeated until all the grid areas are compared or may be stopped if a gear exceeds an acceptable maximum member of “no matches” before all the grid areas are compared. Assuming that the entire grid is compared before a final determination is made, once all the grid areas are compared and the total number of “matches” and “no matches” are determined, and then to total “matches” and “no matches” are compared to a predefined number to determine whether the gear is acceptable or not. Alternately, or in addition, models may be generated that include grid areas or regions that represent bad patterns. Bad patterns of contact areas are identified as set of grid regions with contact areas, which are typically connected together, that, when viewed, appear to experts to be unacceptable. For example, a bad pattern may include contact areas adjacent an edge of the tooth. For each bad pattern, at least one pattern shifted or sized should be included that is just within acceptable limits. The pattern may then matched to a set of good and bad patterns, and the pattern closest to that of the actual tooth then determines the pass/fail and reason for pass/fail (if pattern) for the gear.

This comparison may also include a determination of whether there is a match or whether there is close match. For example, this may be achieved by comparing the actual tooth to a reference model where both good and bad patterns are stored, as well as establishing the areas and locations of the actual pattern centers, heights and widths. This is done for each tooth selected, and in sequence if that is important. Limits can then be placed on the location of contact areas permitted; size, shape (via the method disclosed herein and, if necessary, general shape parameters common in the art) and number of contact areas permitted on a tooth; maximum deviation of contact areas from tooth to tooth; maximum variation of contact area characteristics permitted over entire set of teeth analyzed on a single gear; and other characteristics as desired by those who may be skilled in the art.

Once analyzed, this information may be provided by computer link, by enunciators, by hardcopy, by man-machine interface (e.g. CRT or other display screen) or by some other means to downstream operations. If a gear passes inspection, it may simply continue to final assembly, for example. If a gear fails, but can be quickly repaired, it can be cycled to a repair station, then put back through inspection. If the failure of a gear is of a type or nature that defies repair on the assembly line, it can be cycled to another stream of product destined either for more involved rework, or simply scrapped. In all cases, the specifics of the analysis performed by this invention can be used to provide the specific downstream path to be taken. All this is gained, and a mind-numbing laborious task is automated. Time, labor costs, and specific downstream path information are all gained by such automated means of gear inspection by this invention.

Side benefits for this invention include the following: The ability to provide remote operator viewing of a gear under inspection and the ability to store images and analyses for later accessibility in cases of, for example, automotive/truck recall or suspected poor batch of goods. The former is important because it can provide for human visual inspection prior to the acceptance of the automated inspection technology. This is commonly encountered in today's world of automotive and truck manufacturing. The latter is of advantage because it provides for a means to look back at cases where a recall is deemed necessary and use the recorded information to determine if there is a root cause that can be used to limit the range of gear sets that need to be recalled, thus saving time, money and inconvenience without limiting consumer protection.

### Image Analysis in a Preferred Embodiment

In one preferred embodiment, two color cameras are connected via a link to a PC. One camera views one flank of gear teeth and the other views the other flank of the same teeth. A single strobe light illuminates both flanks of the gear teeth. A near-IR optical fiber optic proximity sensor is used to detect the entry of a gear tooth into the field of view of the camera(s). The PC enables the frame grabber(s) to monitor this sensor, and when the sensor changes state, or generates a signal the frame grabbers linking the cameras to the PC clears the camera(s) and acquires a set of images into the computer memory.

Connectivity analysis is used to find the largest contiguous area on the image of each tooth (hereafter referred to as a blob, a term known to those skilled in the art of image analysis) when the contrast means is pushed or worn away by gear-to-gear contact during rotation of the gear set. As part of the connectivity analysis, various characteristics of the area are recorded, such as the “center of mass” of the region, together with it's rightmost, leftmost, uppermost and lowermost points, all relative to the uppermost, lowermost, leftmost and rightmost edges of the tooth. Process control limits are placed on the acceptable range of positions of the blob area, as well as the wander back and forth and up and down that each of the blobs is allowed from tooth to tooth. These are then further analyzed by the computer program.

Further analysis reveals systematic and random trends. If the position tends to be systematically high or low or left or right, then specific adjustment instructions can be provided to downstream repair operations to move the location of one gear relative to the other to provide a better positioning of the contact surfaces where desired. If the areas are too large or too small, this may indicate other alignment difficulties that may be corrected. Should the position wander in a regular way up then down then up, or left then right then left, there is some mis-alignment of the gear itself and this may indicate that no amount of adjustment will fix the problem. From this, those skilled in the art of manufacturing spiral ring gears can quickly see the power of this analytical method applied directly to the production line.

The cameras in this embodiment are EPIX, Inc. Model SV2112C, having a color imager and digital LVDS interface to a PCI slot based Epix, Inc. Model PIXCI-D2X frame grabber in the PC. The PC is a standard IBM-PC clone typical of this time with a 1.8 GHZ Pentium IV processor, 256 kB DDR RAM, and other hardware typically associated with current day personal computers. A standard 3 m to 10 m long LVDS cable connects each interface board with it's associated camera. The PC itself is ruggedized for use in an industrial environment, and uses a standard Microsoft Windows 2000 Professional operating system. A digital interface board is used to interface with downstream electronics and an ethernet network connection is used for serial communications both with in-factory automation and for use by the provider's service personnel. The PC's serial port is used to communicate with any incoming information about the gear set under test, such as a part number, sequence number, serial number, or other identifying information. If sufficient information is provided, the device can select a specific set of parameters for testing. This ability to use a plurality of testing criteria depending on information supplied is also part of the present invention. Similarly, the present invention may be configured to supply output information in a plurality of means that can accompany the parts or assemblies through the remainder of the manufacturing process. Moreover, since we have cameras present in the preferred embodiment, we also may provide images of one or more gear teeth for each gear tested that can be stored for part history and retrieved later if desired.

The testing method itself can be enhanced if scales are properly set. While scales are useful for test criteria such as runout and high/low, they don't provide for easy scaling to various sized teeth. If, for example, the gears being tested vary in size, but the same basic criteria for meshing is used, then each different size must either have its parameters scaled or have a separate set of parameters. However, if instead we divide each tooth type into a fixed number of grid areas horizontally and vertically in the image, and compare each of these areas with similar areas in a rectangular pattern, each one having exactly the same number of horizontal grid areas and vertical grid areas, then the pattern can be matched easily. This match is scored according to how many of the grid areas match in representing either places where the teeth touched or places where they did not. Further, if the user can set a variety of patterns, and signal whether a pattern is good or bad, then develop a scheme of having a set of patterns where for every good pattern or bad pattern entered, a corresponding just bad or just good pattern, respectively is also in place. Then the best score of all the matches is used to give a pass/fail signal. If it fails, then the specific reason for failure can be assigned based on the specific pattern that provided the best match to the image. Finally, if the criteria are the same for all sizes/types of gears under test, and the outline of the gear can be determined for each type in the image, then one set of test criteria may suffice for all types of gears. This may be especially useful in cases where the gear types present vastly different aspect ratios (height/width) to be inspected. It is clear that the scoring method itself can vary from gear to gear, and can even include characteristics of patterns that we do not illustrate in this embodiment, though they are clearly anticipated by the present teaching.

Initial testing of the apparatus disclosed provided proof of acceptable match to human based visual inspection. We anticipate that this device can be improved to take more fully into account the shape of a pattern, the divisions of a pattern into several segments, the use of alternative lighting and timing schemes, a change in optics either for the present embodiment or in cases where gears are not so visible or easily accessible to even human visual inspection, and other improvements that accompany hardware or software changes.

In no case is the preferred embodiment limiting our envisioned methods or apparatus. Although illustrated as discrete components, the entire inspection system may be incorporated into a self contained system where the camera(s) and computer are integrated. It should be understood that the lighting and camera shuttering may be adjusted to provide better images. Further, the method of analysis may vary, and may be based on the specific needs expressed by manufacturers or others as those needs surface. We anticipate improvement owing to changes in optics that more efficiently use camera imagers or which allow better access to see gears and how they mesh than simple straight line through-the-lens imaging. For example, a device where the light path is incorporated into a lens structure through a beam splitter or other arrangement may provide better lighting. The lighting could come from a single light source and be split via beam splitter and/or fiber optic splitting, as examples. All the varied methods for both hardware and software based on the imaging method disclosed and the analysis method disclosed are anticipated by the present invention. We envision a method and apparatus where something other than colored fluid is used for contrast as well as a method where the simple surface changes that occur with running gears together are used thereby avoiding use of any substance.

While several forms of the invention have been shown and described, other changes and modifications will be appreciated by those skilled in the relevant art. For example, while several embodiments have been described in reference to spiral bevel gears, the present application is not so limited and instead can be used with other types of gears. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A method of inspecting a gear, the gear having a plurality of gear teeth, each tooth having two flanks, the gear having a contact area generated on each flank of each tooth, said method comprising:
rotating the gear;
providing an imaging device;
gathering images of the flanks of the gear teeth with the imaging device while rotating the gear; and
analyzing the images of the flanks of the gear teeth to evaluate the contact areas on the teeth to determine whether the contact areas are acceptable.

2. The method according to claim 1, further comprising providing a processor, said analyzing comprises analyzing the images with the processor.

3. The method according to claim 1, further comprising illuminating each flank of each tooth while gathering the images.

4. The method according to claim 3, wherein said illuminating includes illuminating each flank with a strobe light.

5. The method according to claim 1, wherein said gathering images includes gathering all the images of the flanks of the teeth prior to analyzing the images.

6. The method according to claim 1, wherein said gathering images includes gathering one image of one flank of one tooth of the gear and analyzing the one image.

7. The method according to claim 1, wherein said gathering images includes gathering at least one image of one flank of one tooth of the gear and analyzing the at least one image.

8. The method according to claim 1, further comprising providing a reference pattern of an acceptable or unacceptable contact area pattern, said analyzing including comparing the pattern of contact areas on the gear teeth to the reference pattern.

9. The method according to claim 1, further comprising providing a reference tooth: flank, dividing the reference tooth flank into grid areas, indicating selected grid areas of said grid areas where a contact area may occur, dividing each flank of the analyzed gear teeth into a plurality of grid areas, and said analyzing including comparing the correspondence of the locations of the contact areas relative to the grid areas of the analyzed tooth to the contact areas on the grid areas of the reference tooth.

10. The method according to claim 9, wherein said indicating selected grid areas of said reference tooth flank includes indicating where an acceptable contact area may occur.

11. The method according to claim 1, wherein said providing an imaging device includes providing at least two imaging devices, said gathering images includes gathering images one set of flanks of the gear teeth with one of the imaging devices and gathering images of another set of flanks of the gear teeth with the other imaging device.

12. The method according to claim 1, wherein the imaging device has a field of view, said method further comprising detecting when the gear tooth is in the field of view of the imaging device.

13. A gear inspection apparatus for inspecting a gear with a plurality of gear teeth, each tooth having first and second faces, the gear having being driven by another gear to generate contact areas on each of said first and second faces, said apparatus comprising:
at least one imaging device;
means for rotating the gear during an inspection cycle; and
a processor, said imaging device gathering images of the flanks of the teeth of the gear during said inspection cycle, said processor processing said images and using said images to analyze the contact areas of the teeth of the gear to evaluate the gear.

14. The apparatus according to claim 13, wherein said imaging device gathering images of the faces of the teeth of the gear while the gear is rotating.

15. The apparatus according to claim 13, wherein said imaging device comprises a pair of imaging devices, one of said imaging devices gathering images of the first faces of the gear teeth and another of said of said imaging devices gathering images of the second faces of the gear teeth.

16. The apparatus according to claim 13, wherein said imaging device comprises a camera.

17. The apparatus according to claim 13, further comprising a light source for illuminating each flank of the teeth while said imaging device gathers the images of said flanks of the teeth.

18. The apparatus according to claim 17, wherein said light source generates a strobe light.

19. The apparatus according to claim 13, wherein said processor is programmed to analyze the images after all the images of the flanks of the teeth are gathered.

20. The apparatus according to claim 13, wherein said processor is programmed to analyze an image of one or more flanks prior to gathering all of the images of the flanks of the teeth of the gear.

21. The apparatus according to claim 13, wherein said processor includes a reference pattern of an acceptable or unacceptable contact area pattern, said processor comparing the pattern of contact areas on the gear teeth to the reference pattern.

22. The apparatus according to claim 13, wherein said processor divides the flanks of the teeth into grid areas, and said processor comparing the pattern of the contact areas in the grid areas of the analyzed tooth to a reference pattern on the grid areas on a reference tooth.

23. The apparatus according to claim 13, further comprising a sensor, said imaging device having a field of view, said sensor detecting when the gear tooth in is said field of view of the imaging device.

24. The apparatus according to claim 23, wherein said sensor is in communication with said processor.

25. The apparatus according to claim 23, wherein said sensor generates a trigger signal, said processor initiating said imaging device to gather images when said trigger signal is generated.

26. The apparatus according to claim 13, wherein said processor is in communication with said imaging device.

27. The apparatus according to claim 13, wherein said imaging device includes said processor.
